(19) United States
(12) Patent Application Publication
(10) Pub. No.: US 2005/0151345 A1
(43) Pub. Date: Jul. 14, 2005

(54) Foldable bike capable of standing and being pulled after folded

(76) Inventor: Ji-Huang Chen, Chung-Li (TW)

Correspondence Address: Ji-Huang Chen, 235 Chung-Ho, Box 8-24, Taipei, TW

(21) Appl. No.: 11/029,720

(22) Filed: Jan. 6, 2005

(30) Foreign Application Priority Data
Jan. 14, 2004 (TW) 093200637

(51) Int. Cl. B62K 3/00

(52) U.S. Cl. 280/287

(57) ABSTRACT

A foldable bike is capable of standing and being pulled after folded. The foldable bike comprises a body having a support frame which stand uprightly; a top end of the support frame being installed with a cushion; a front wheel unit connected to one end of the body; the front wheel unit having a front shaft unit which is connected to the body; the front wheel unit being rotatable with respect to the body; a rear wheel unit connected to another end of the front wheel unit by a rear shaft unit thereof; the rear shaft unit including a rear wheel support frame; the orientation of the rear wheel unit being changeable with respect to the body by using the rear shaft unit; wherein by about structure, the body, the front wheel unit, and the rear wheel unit are foldable and expandable.

### FIELD OF THE INVENTION

The present invention is related to bikes, and particularly to a foldable bike capable of standing and being pulled after folded, wherein after folded, the foldable bike can stand on the ground as a long strip so as to occupy a small volume. As a result, it can be placed within a car catridge box.

### BACKGROUND OF THE INVENTION

Currently, bicycles or electromotive bikes are more and more popular in the market. However to be stored and carried easily and conveniently, the bicycles or electromotive bikes are designed to be foldable. These bicycles or electromotive bikes are designs as two folding sections so that they occupy larger volumes after being folded. Thereby the folded bicycles or electromotive bikes can not stand so that if they are transferred, the users must hold them without contacting the ground and thus the works are tedious and hard.

### SUMMARY OF THE INVENTION

Accordingly, the primary object of the present invention is to provide a foldable bike capable of standing and being pulled after folded, wherein after folded, the foldable bike can stand on the ground as a long strip so as to occupy a small volume. As a result, it can be placed in a rear box of a car.

Thereby the foldable bike is divided into a body, a front wheel unit, and a rear wheel unit, there are three folding sections so as to occupy a smaller volume.

Thereby the foldable bike has a power storage device which has a supporter. The supporter is grounded to stand on the ground.

Moreover, after folded, the rear wheel unit is grounded so that the foldable bike can be pulled to move easily.

The various objects and advantages of the present invention will be more readily understood from the following detailed description when read in conjunction with the appended drawing.

### BRIEF DESCRIPTION OF THE DRAWINGS

FIG. 1 is an expanded perspective view of the present invention.

FIG. 2 shows the application of the present invention.

FIG. 3 is an expanded elevational view of the present invention.

FIG. 4 is a perspective view showing the structure of the front wheel of the present invention before folded.

FIG. 5 is a lateral view showing the structure of the front wheel of the present invention before folded.

FIG. 6 is an elevational view shows the structure of front wheel of the present invention before folded.

FIG. 7 is a perspective view about the assembly of the rear wheel of the present invention after folded.

FIG. 8 shows the structure of the rear wheel of the present invention after folded.

FIG. 9 shows the elevation view of the assembly of the rear wheel of the present invention after folded.

FIG. 10 is a schematic view about the adjustment of the handle according to the present invention after folded.

FIG. 11 is a schematic view about the movement of the present invention after folded.

FIG. 12 is a schematic view showing that a bag is added to the present invention.

FIG. 13 shows another embodiment of the present invention.

FIG. 14 shows a further embodiment of the present invention, where auxiliary wheels are added.

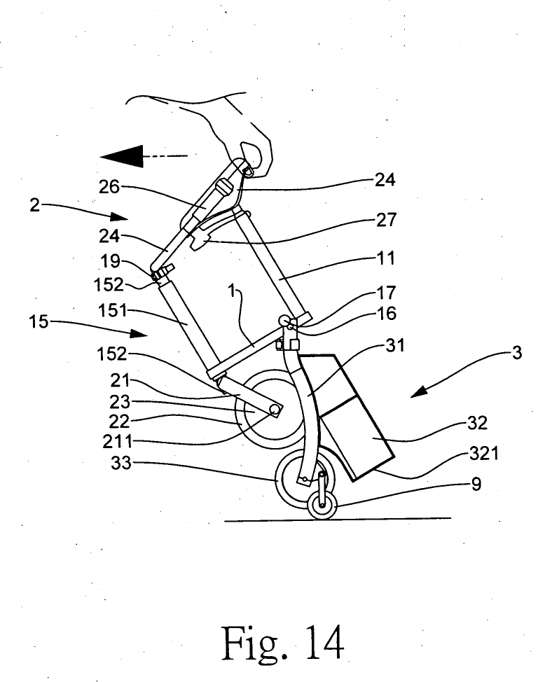

FIG. 15 shows a yet embodiment of the present invention, where a treading power unit is added.

FIG. 16 shows a folded view of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

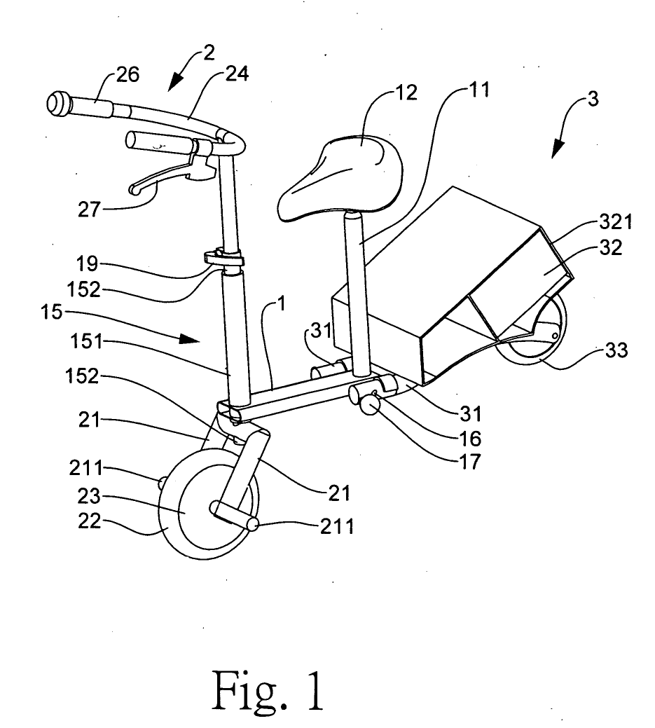

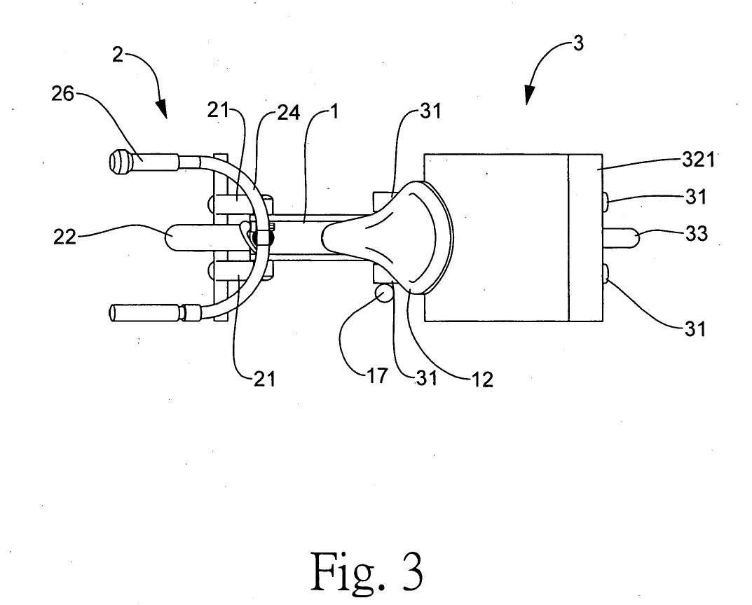

Referring to FIGS. 1 to 3, the foldable bike capable of standing on the ground and being pulled after folded according to the present invention is illustrated. The foldable bike has the following elements.

A body 1 has a support frame 11 which stand uprightly. A top end of the support frame 11 is installed with a cushion 12.

A front wheel unit 2 is connected to one end of the body 1. The front wheel unit 2 has a front shaft unit 15 which is connected to the body 1. The front wheel unit 2 is rotatable with respect to the body 1. The front wheel unit 2 has a front biforked frame 21 which has a U shape. The front shaft unit 15 has an outer sleeve 151 and an inner shaft 152 inserted into the outer sleeve 151 to be rotated therein. A bottom of the inner shaft 152 is connected to the front biforked frame 21. Two ends of the front biforked frame 21 are extended with two treading bars 211, respectively. A front wheel 22 is pivotally installed between the two treading bars 22. A wheel motor 23 is installed within the front wheel 22. The motor 23 serves to drive the front wheel 22. A top end of the front shaft unit 15 is installed with a Y shape handle 24. A bottom of the handle 24 is connected to the inner shaft 152 so that the handle 24, the inner shaft 152 and the front biforked frame 21 are interacted. An accelerator 25 and a brake 27 and an elevational adjust unit 19 are installed to the handle 24.

A rear wheel unit 3 is connected to another end of the front wheel unit 2 by a rear shaft unit 16 thereof. The rear shaft unit 16 includes a rear wheel support frame 31. A tail of the rear wheel support frame 31 is arranged with a rear wheel 33. A power storage device 32 is installed to the rear wheel support frame 31 The power storage device 32 may be a battery for supplying power to the motor 23. A rear side of the power storage device 32 is installed with a supporter 321. A buckle 17 is installed to the rear wheel support frame 31.

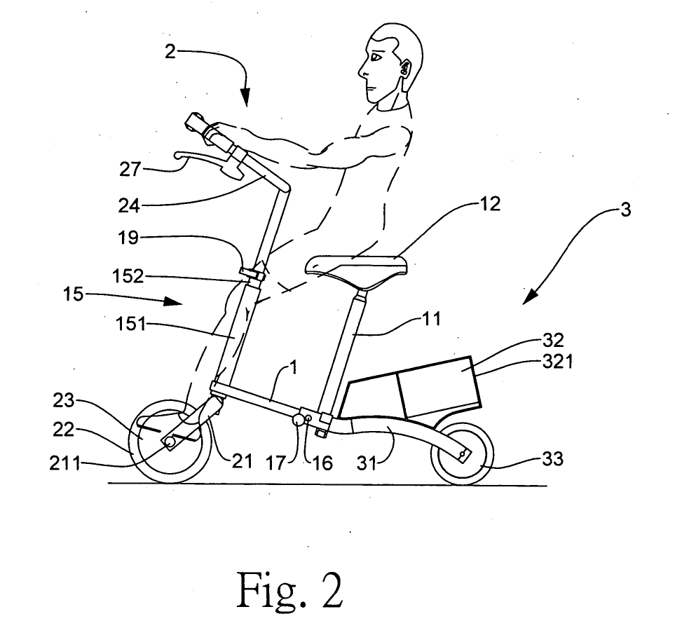

In the driving operation of the present invention, see FIG. 2, the bottom of the rider will sit on the cushion 12. Two legs tread upon the treading bars 211 and two hands hold the distal ends of the handle 24 so as to operate the accelerator 26 and the brake 27.

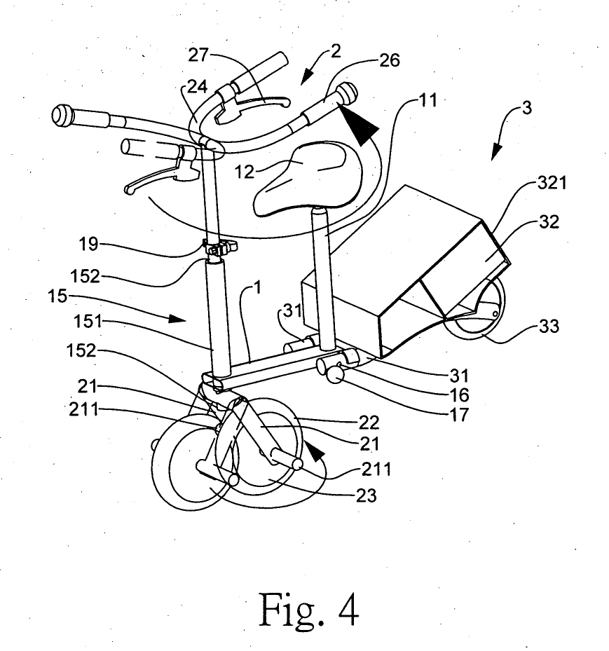

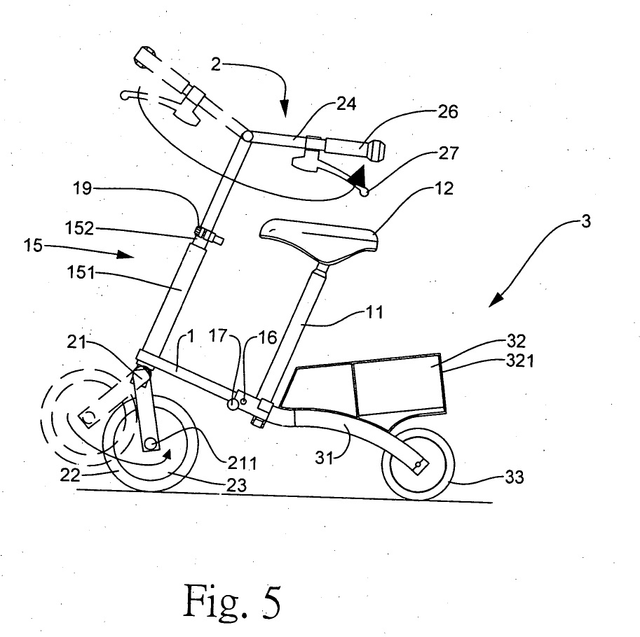

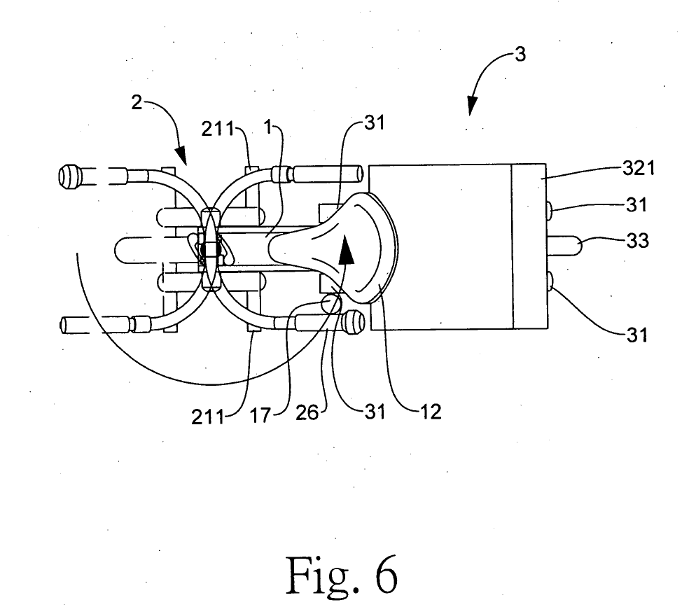

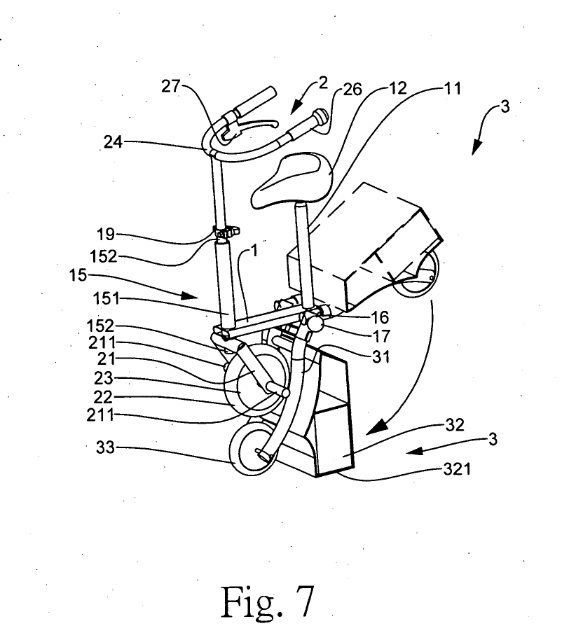

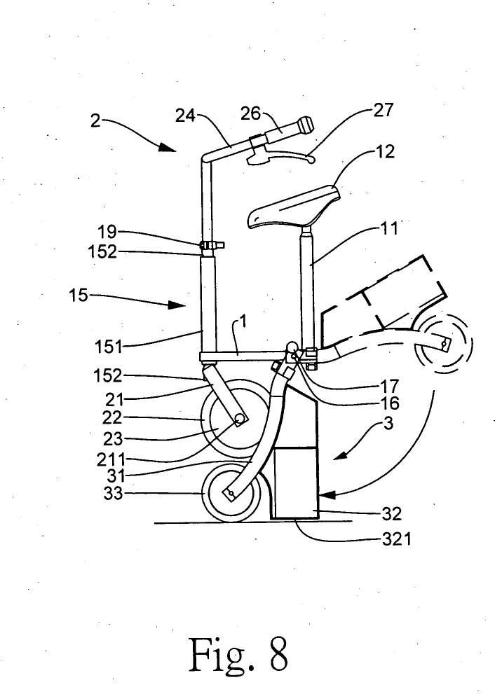

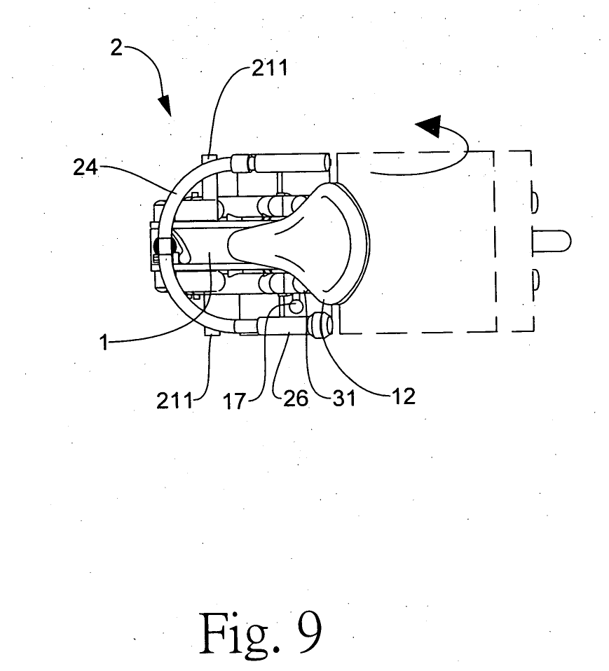

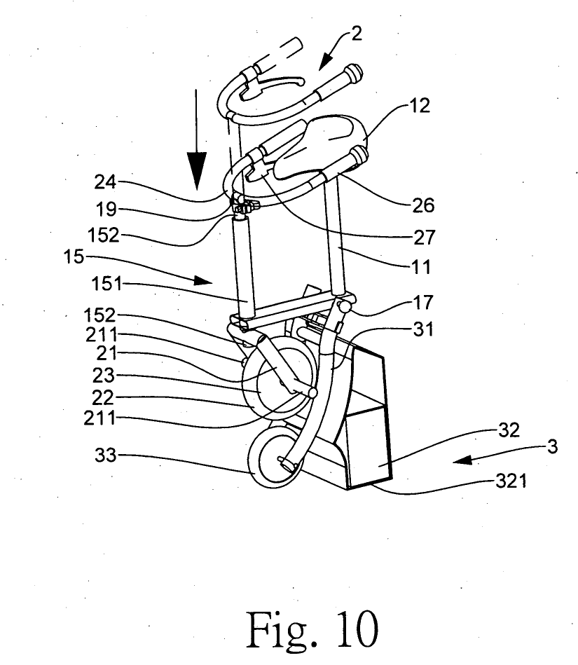

When it is desired to fold the bike, referring to FIGS. 4, 5 and 6, the front wheel unit 2 is folded with respect to the body 1. Then the rear wheel unit 3 is folded to the bottom of the body 1 by using the rear shaft unit 16. With reference to FIGS. 7, 8, and 9, the rear wheel unit 3 moves to be near the bottom of the body 1 and is then buckled by the buckle 17. The operation is convenient and rapid. After folding since the rear wheel unit 3 and the body 1 are steadily connected and the front wheel 22 is exactly clamped in the rear wheel support frame 31. Thereby the front shaft unit 15 cannot rotate as desired. Thus, the body 1, front wheel unit 2 and rear wheel unit 3 are steadily folded. Finally, see FIG. 10, the elevation of the handle 24 is descended so as to reduce the volume. Thus, the folding operation is complete.

When the foldable bike of the present invention is folded as those illustrated in FIGS. 7, 8, and 9, it is as a stand upright strip. Advantages of the present invention will be described herein.

The rear wheel 33 of the foldable bike is grounded and the supporter 321 of the power storage device 32 is also grounded so that the foldable bike can steadily stand upon the ground. Thereby the volume for storage can be saved.

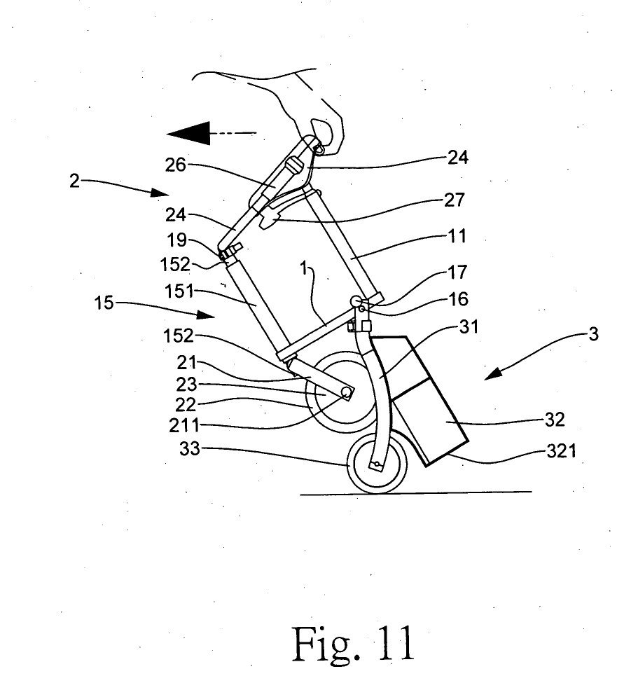

Since the rear wheel 33 is grounded, the rider can hold the lower sides of the cushion 12. The rider can move the bike by pulling the rear wheel 33 so as to save the force necessary (referring to FIG. 11).

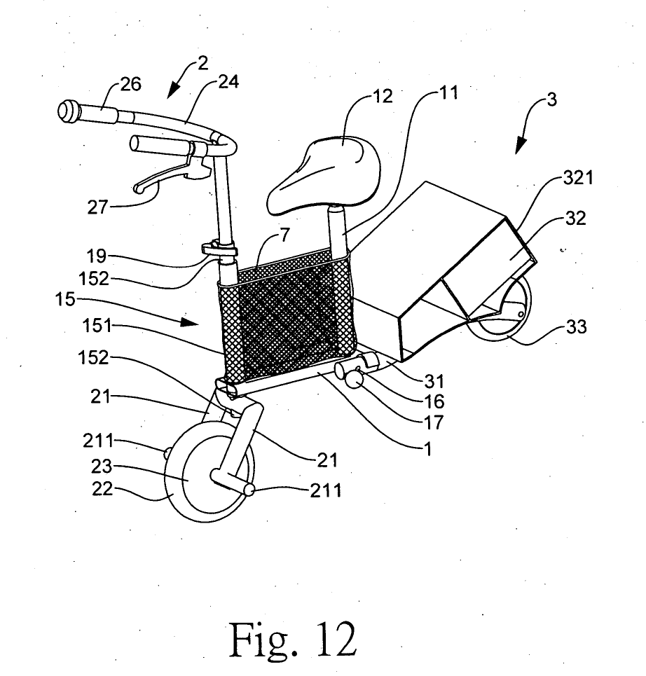

The structure of the present invention is shown in FIG. 12. A bag 7 is placed around the support frame 11 and the outer sleeve 151 for receiving objects

In the present invention, other than using a motor 23 to drive the front wheel 22, the front wheel 22 can be driven by an external engine or an external motor. Thereby the power storage device 32 may be installed at any place of the bike. Further, other than installing on the front wheel 22, the motor 23 can be installed to the rear wheel 33.

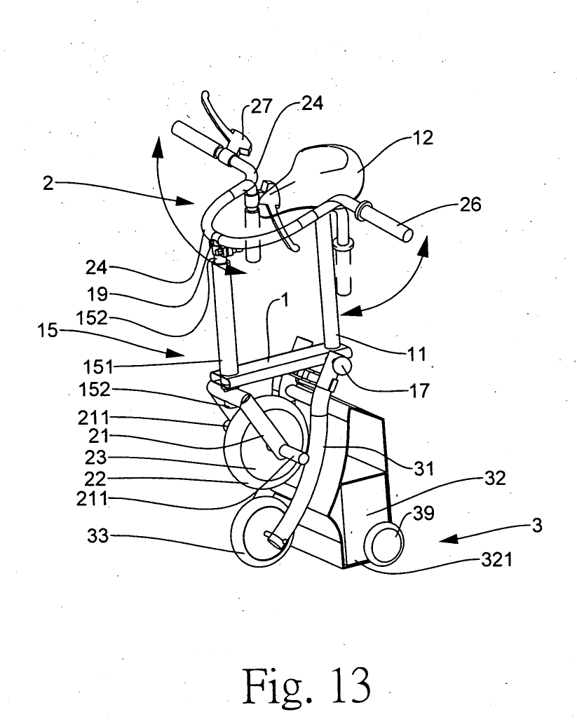

FIG. 13 shows another embodiment of the present invention, wherein two ends of the handle 24 locating the accelerator 26 and the brake 27 are bendable. The rear wheel unit 3 can be installed with two auxiliary wheels 39 for being pulled reversely.

A further embodiment of the present invention is illustrated. Two sides of the rear wheel 33 are arrangement with two orientation-changed auxiliary wheels 9. Thereby the bike can be pulled conveniently and the auxiliary wheel can be used as a lower frame 9.

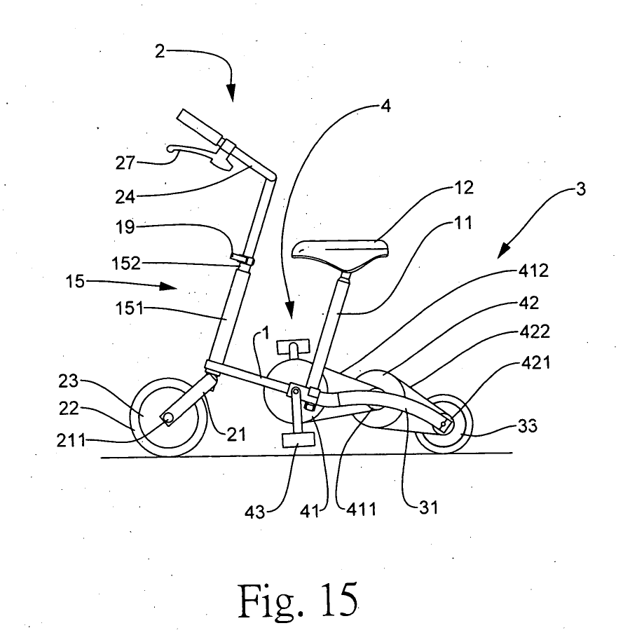

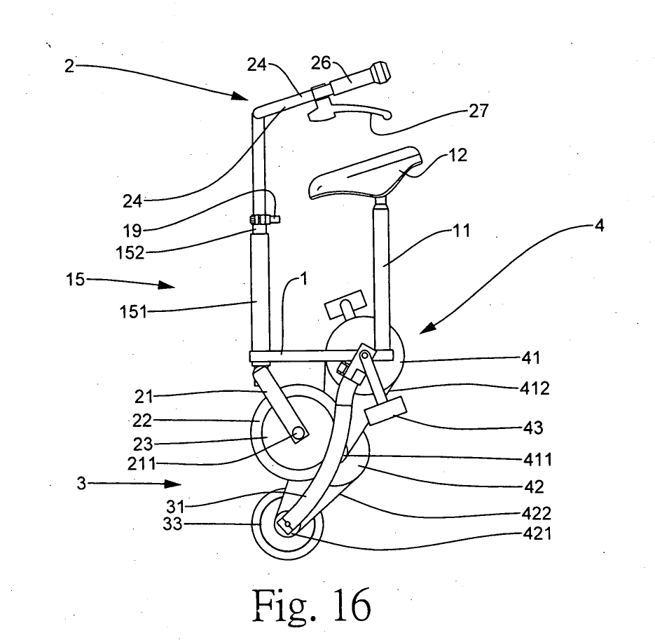

FIGS. 15 and 16 are a further embodiment of the present invention. A manpower bike is illustrated. A treading power unit 4 is installed between the rear wheel unit 3 and the body 1. The treading power unit 4 includes a main wheel 41, a first driving wheel 411, a first driven wheel 412, a second driven wheel 42, a third driven wheel 421, a second driving wheel 422 and treadles 43. In driving, two legs tread upon the treads 43 so as to drive the main wheel 41, a first driving wheel 411, the first driven wheel 412, the second driven wheel 42, the second driving wheel 422, the third driven wheel 421, and then the rear wheel 33.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A foldable bike capable of standing and being pulled after folded, the foldable bike comprising:
a body having a support frame which stand uprightly; a top end of the support frame being installed with a cushion;
a front wheel unit connected to one end of the body; the front wheel unit having a front shaft unit which is connected to the body; the front wheel unit being rotatable with respect to the body;
a rear wheel unit connected to another end of the front wheel unit by a rear shaft unit thereof; the rear shaft unit including a rear wheel support frame; the orientation of the rear wheel unit being changeable with respect to the body by using the rear shaft unit;
wherein by about structure, the body, the front wheel unit, and the rear wheel unit are foldable and expandable.

2. The foldable bike capable of standing and being pulled after folded as claimed in claim 1, wherein the cushion is installed at a top of a support frame and the support frame are installed to the body.

3. The foldable bike capable of standing and being pulled after folded as claimed in claim 1, wherein a power storage device is installed; the power storage device includes a supporter which can stand upon the ground; and the power storage device is a battery.

4. The foldable bike capable of standing and being pulled after folded as claimed in claim 1, wherein the front shaft unit has an outer sleeve and an inner shaft inserted into the outer sleeve to be rotated therein; a bottom of the inner shaft is connected to the front biforked frame and a top of the inner shaft is connected to a bottom of the handle.

5. The foldable bike capable of standing and being pulled after folded as claimed in claim 1, wherein two ends of the front biforked frame are extended with two treading bars, respectively.

6. The foldable bike capable of standing and being pulled after folded as claimed in claim 1, wherein a motor is installed in one of the front wheel and rear wheel.

7. The foldable bike capable of standing and being pulled after folded as claimed in claim 1, wherein the wheels of the foldable bike is driven by an external motor or an external engine.

8. The foldable bike capable of standing and being pulled after folded as claimed in claim 1, wherein after folding, the front wheel unit and rear wheel unit are positioned to the body.

9. The foldable bike capable of standing and being pulled after folded as claimed in claim 1, wherein two ends of the handle are bendable and the rear wheel unit is installed with auxiliary wheels.

10. The foldable bike capable of standing and being pulled after folded as claimed in claim 1, wherein a treading power unit is installed between the rear wheel unit and the body; the treading power unit includes a main wheel, a first driving wheel, a first driven wheel, a second driven wheel, a third driven wheel, a second driving wheel and treadles.
